(19) United States
(12) Patent Application Publication
(10) Pub. No.: US 2020/0079374 A1
(43) Pub. Date: Mar. 12, 2020

(54) INTELLIGENT STOP AND START (STT) SYSTEM AND METHOD THEREOF

(71) Applicant: Huizhou Desay SV Automotive Co, Ltd., Guangdong (CN)

(72) Inventors: Yongzheng DUAN, Guangdong (CN); Li HUANG, Guangdong (CN); Zuohuang LUO, Guangdong (CN)

(21) Appl. No.: 16/614,372

(22) PCT Filed: Oct. 27, 2017
(86) PCT No.: PCT/CN2017/108074

§ 371 Date: Nov. 18, 2019

(30) Foreign Application Priority Data
Sep. 30, 2017 (CN) 201710917530.6

(51) Int. Cl. B60W 30/18; B60W 40/04; G06K 9/00

(52) U.S. Cl. CPC B60W 30/18018; B60W 40/04; B60W 2420/42; B60W 2550/30; G06K 9/00825

(57) ABSTRACT

The present invention relates to an intelligent stop and start (STT) method and a system thereof, wherein the system comprises a camera and a processor for capturing and analyzing an image captured by the camera, and in particular, the method comprises steps of: S1, identifying the presence of a traffic light ahead of the vehicle and a traffic light state by means of image identification; obtaining the vehicle speed of the vehicle within the image identification range by means of image identification, while determining a road congestion state in combination with its own vehicle speed and the traffic light state; S2, suppressing the intervention of the STT system when the current road congestion state is determined as a traffic congestion: otherwise, determining the current road congestion state as a good road state to allow the intervention of the STT system. The present invention has the following beneficial effects: 1. With the combination of visual processing of the camera for the front, the state of the target ahead of the vehicle and the state of the traffic lights are obtained to determine the current traffic environment, importantly, to determine whether it is currently in a state of traffic congestion, so as to solve the widely complained problem of frequently starting and stopping resulted from the STT system in traffic lams.

### BACKGROUND OF THE INVENTION

The present invention relates to the technical field of automobile energy-saving system, in particular, to an intelligent stop and start (STT) system and a method thereof.

The STT system is designed to shut down the engine when the engine is idling. When the engine is stopped, the STT system will control the vehicle to no longer consume fuel and generate emissions. The conventional STT system is a system for controlling the start and stop of the vehicle powertrain, wherein the state of the vehicle is determined by the control unit, for example, when the vehicle is in a stagnant state such as in a red light or a blockage, the system controls the engine to automatically stop running, and the transmission is disconnected from the power transmission; when the driver has a requirement for starting, such as releasing the brake pedal or depressing the accelerator pedal, the engine immediately restarts, and the transmission simultaneously responds to the restart request from the engine to quickly engage the clutch to ensure a comfortable start. The STT system shuts down the engine when the vehicle is idling, which reduces fuel consumption and carbon dioxide emissions when the engine is idling, thereby reducing vehicle noise. Relevant experiments have proved that the SIT system can reduce energy consumption and emissions by about 8% under comprehensive working conditions, and the energy-saving effect in a congested urban area can reach up to 10%-15%. Installing the STT system has a small incremental cost and little change on the existing powertrain system, but is very suitable for urban road conditions and has strong practical value. Also, in addition to the advantages of fuel economy itself, it is more in line with the construction concept of a low-carbon society that is strongly advocated at present.

However, the current STT technologies for the engine mostly come from abroad, and have good performance under good road conditions in countries such as Europe or America. But in more complicated road conditions in China, especially the particularly congested road conditions, the STT technology not only fails to achieve the original energy-saving effect, but also greatly reduces the user's driving comfort due to frequent start and stop when in congested conditions.

In the prior art, in order to improve the practicality, some solutions adopt a way of combining with the vehicle network, wherein the road congestion condition of the current location of the vehicle is obtained through the network to control the activation or shutdown of the STT system. However, the method has to add a remote communication system while having higher requirements on the network, so the practical application is not very significant.

### BRIEF SUMMARY OF THE INVENTION

In order to solve the problems of the prior art, the present invention provides an intelligent stop and start (STT) method and a system thereof.

An intelligent start and stop (STT) method for acquiring a road congestion state and an identification state of traffic lights through image data ahead of the vehicle to allow or suppress the intervention of the STT system; the acquiring a road congestion state and an identification state of traffic lights comprises steps of:

S1, identifying the presence of a traffic light and a traffic light state ahead of the vehicle by means of image identification; obtaining the vehicle speed of the vehicle within the image identification range by means of image identification, while determining a road congestion state in combination with its own vehicle speed and the traffic light state;

S2, suppressing the intervention of the STT system when the current road congestion state is determined as a traffic congestion; otherwise, determining the current road congestion state as a good road state to allow the intervention of the STT system.

Further, the determining a single road congestion state in the step S1 includes at least one of the following determining conditions:

determining as the traffic congestion state when its own vehicle speed and the vehicle speed within the image identification rage are smaller than a low-speed threshold and the current state is not a state in red light;

determining as a good road state when its own vehicle speed or any of the vehicle speeds within the image identification rage are smaller than a low-speed threshold and the current state is a state in red light.

As a further optimization of the above method, the road congestion state further includes a temporary congestion state, during which the intervention of the STT system is allowed.

Further, the determining a single road congestion state in the step S1 includes at least one of the following determining conditions:

determining as the traffic congestion state when its own vehicle speed and the vehicle speed within the image identification rage are smaller than a low-speed threshold and the current state is not a state in red light;

determining as a good road state when its own vehicle speed and any of the vehicle speeds within the image identification rage are larger than a high-speed threshold;

having to enter into the temporary congestion state when the road congestion state is in a good road state and the traffic congestion state is met, and determining as the traffic congestion state when a duration for the temporary congestion state exceeds a first buffer threshold;

determining as the temporary congestion state when the road congestion state is a state of traffic congestion, and a duration for its own vehicle speed being zero exceeds a second buffer threshold, or when in a state of red light currently.

As a further refinement of the above method the method for identifying the traffic light state within the image identification rage in the step S1 includes steps of

S111, acquiring an image information ahead of the vehicle currently, and performing a pre-treatment;

S112, detecting the traffic light by HOG feature detection, and marking the detected traffic light if any and sorting out the image in the identification region if there is a traffic light in the current image information;

S113, analyzing the signal type of the traffic light in the image in the identification region by a convolutional neural network and outputting.

As a further refinement of the above method, the method for identifying the vehicle within the image identification rage in the step S1 includes steps of:

S121, acquiring an image information ahead of the vehicle in the current moment, and performing a pre-treatment;

S122, detecting the vehicle existing in the image by HOG feature detection, and marking the detected vehicle if there is a vehicle in the current image information;

S123, acquiring an actual relative location and distance between the vehicle ahead and the present vehicle according to an orientation and an area of the vehicle in the image.

Among them, the step S122 includes sub-steps of:

S1221, performing a standard treatment on a GAMMA space and a color space of the image;

S1222, calculating the gradient of the image for constructing a gradient direction histogram for each cell unit;

S1223, combining the cell unit into a large block and normalizing the gradient histogram within the block;

S1224, counting and analyzing HOG features for vehicle detection.

Further, the vehicle within the image identification range includes a vehicle directly ahead of the vehicle and/or a vehicle in an adjacent lane ahead.

Preferably, the low-speed threshold is any value between 10 km/h and 20 km/h; the high-speed threshold is any value between 28 km/h and 32 km/h; the first buffer threshold is 1 min; the second buffer threshold is 1 min.

In addition, the present invention further provides an intelligent stop and start (STT) system comprising a camera and a processor for capturing and analyzing an image captured by the camera; the processor is operated by using the above intelligent STT method.

The intelligent stop and start (STT) method and a system thereof of the present invention have the following beneficial effects:

1. In the present invention, with the combination of visual processing of the camera for the front, the state of the target ahead of the vehicle and the state of the traffic lights are obtained to determine the current traffic environment, importantly, to determine whether it is currently in a state of traffic congestion, so as to solve the widely complained problem of frequently starting and stopping resulted from the STT system in traffic jams.

2. The application of the present patent will be able to avoid 90% of start-stop actions during congestion, and also improve the life of the engine, STT system and the life of battery.

### BRIEF DESCRIPTION OF THE DRAWINGS

FIG. 1 is a structural diagram of an intelligent STT system in Embodiment 1 of the present invention.

FIG. 2 is a diagram of a method in Embodiment 2 of the present invention.

FIG. 3 is a view of vehicle detection in Embodiment 2 of the present invention.

FIG. 4 is a view showing the conversion of road congestion states in Embodiment 3 of the present invention.

FIG. 5 is a flow chart of a method for identifying the traffic light state in Embodiment 4 of the present invention.

FIG. 6 is a structural view of analysis of convolutional neural network in Embodiment 4 of the present invention.

FIG. 7 is a flow chart of a method for identifying the relative location and the speed of the vehicle in Embodiment 5 of the present invention.

FIG. 8 is a flow chart of a method for vehicle detection using HOG in Embodiment 5 of the present invention.

### DETAILED DESCRIPTION OF THE INVENTION

The preferred embodiments of the present invention are described in detail below with reference to the accompanying drawings, in which the advantages and features of the invention are more readily understood by those skilled in the art, so that the scope of protection of the present invention is more clearly defined.

### Embodiment 1

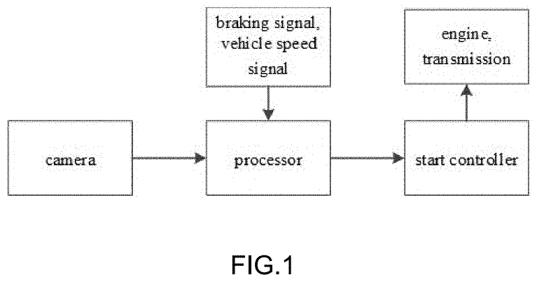

The present embodiment provides an intelligent stop and start (STT) system comprising, as shown in FIG. 1, a camera, a processor and a start controller.

Among them, the start controller is used for controlling the ignition and flameout of an engine according to the specific command of the processor, and the camera is disposed directly ahead of the vehicle or at the front windshield. The camera used in the present embodiment is a monocular camera, which may realize the acquisition of a graphic with a distance ahead of 160 meters and a coverage angle of 50 degrees. Thus, it is applied for visual detections such as lane detection, detection of vehicles ahead and identification of traffic signs.

After the processor acquires the image acquired by the camera, it determines the current road congestion state and the traffic light state ahead, so as to combine the traffic light state and the congestion state to control whether the STT system is allowed to enter the driving process, thereby greatly improving the intelligence and practicality of the STT system, achieving the advantage of the STT system when waiting for the traffic light normally, and reducing the trouble caused by frequent start and stop during congestion.

### Embodiment 2

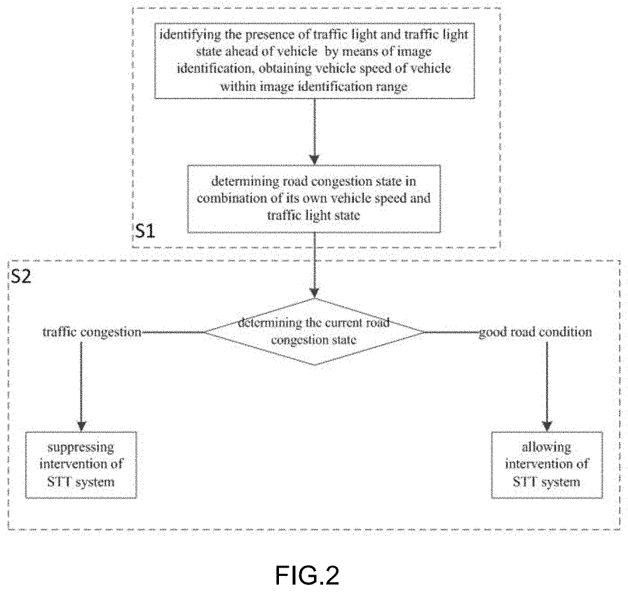

Based on Embodiment 1, the present embodiment provides an intelligent stop and start (SIT) method, which analyzes the image data ahead of the vehicle to obtain the road congestion state of the current road segment where the vehicle is located, and identifies the state of the traffic lights if there is a traffic light in the road segment for further allowing or suppressing the intervention of the STT system according to the identified results. Specifically, as shown in FIG. 2, the acquiring a road congestion state and an identification state of traffic lights comprises steps of:

S1, on the one hand, determining whether there is a traffic light ahead of the vehicle by means of image identification, and if any, identifying the state of the traffic light; on the other hand, obtaining the vehicle speed of the vehicle within the image identification range by means of image identification; while determining the road congestion state in combination of its own vehicle speed and the traffic light state.

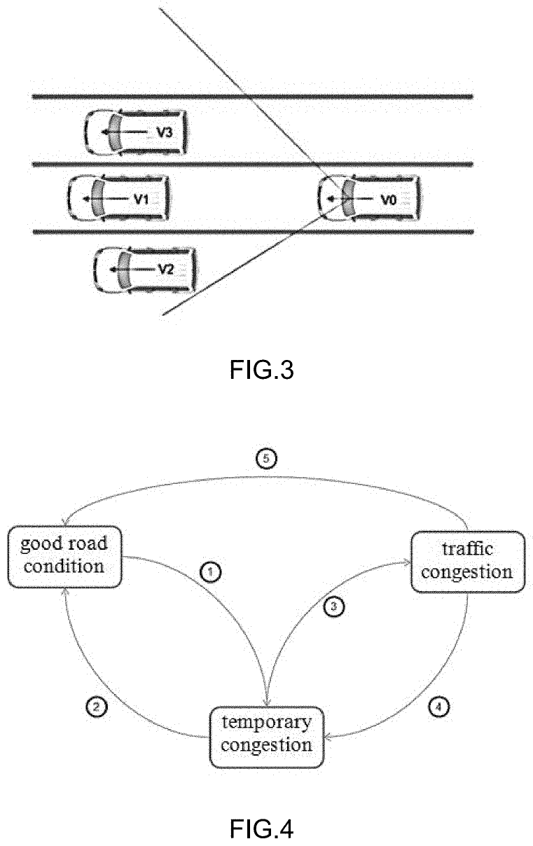

In the present embodiment, the vehicle within the image identification range includes a vehicle directly ahead of the vehicle and/or a vehicle in an adjacent lane ahead, as shown in FIG. 3.

The road congestion state includes a good road condition and a traffic congestion state.

S2, after identifying the current road congestion state, suppressing the intervention of the STT system when the current road congestion state is determined as a traffic congestion; otherwise, determining the current road congestion state as a good road state to allow the intervention of the STT system.

In the present embodiment, the determining the road congestion state includes:

first, for determining the traffic congestion state: determining as the traffic congestion state when its own vehicle speed and the vehicle speed within the image identification rage are smaller than a low-speed threshold and the current state is not a state in red light;

for determining the good road condition: determining as a good road state when its own vehicle speed or any of the vehicle speeds within the image identification rage are smaller than a low-speed threshold and the current state is a state in red light.

Among them, preferably, in the present embodiment, the low-speed threshold is any value between 10 km/h and 20 km/h, further preferably 15 km/h. The high-speed threshold is any value between 28 km/h and 32 km/h, further preferably 30 km/h.

### Embodiment 3

As an optimization of Embodiment 2, the present embodiment is different from Embodiment 1 in that as shown in FIG. 4, the present embodiment divides the road congestion state into three states of good road condition, temporary congestion and traffic congestion. The added temporary congestion state is to provide a buffer state between the two states of good road condition and traffic congestion for making the STT system more stable and reliable while avoiding a congestion condition.

Among them, when in two states of the good road condition and the temporary congestion, the system still allows the intervention of the STT system, that is, the vehicle may still stop and turn off when the requirements for the intervention of the STT system are met. When in the state of traffic congestion, the vehicle may not stop and turn off through suppressing the intervention of the STT system, that is, the vehicle may not stop and turn off though the requirements for the intervention of the SIT system are met.

Specifically, as shown in FIG. 4, the conditions for the conversion of above states are as follows:

Condition 1: from when the vehicle speed is lower than the low speed threshold, and when the vehicle speed of the vehicle ahead is in the low-speed threshold, and when the number of the vehicles on the left and right sides is ≥2, and when the vehicle speeds of the vehicles on the left and right sides are in the low-speed threshold, and when the current state is not a state of waiting-a-red-light.

Condition 2: from when the vehicle speed is higher than or equal to the low-speed threshold, or when the vehicle speed of the vehicle ahead is in the high-speed threshold, or when the number of the vehicles on the left and right sides is <2, or when the vehicle speeds of the vehicles on the left and right sides are in the high-speed threshold, or when the current state is a state of waiting-a-red-light.

Condition 3: the time when the system is in the temporary congestion state is greater than or equal to the first buffer time.

Condition 4: from when the time when the vehicle speed is 0 km/h continuing to exceed the second buffer time, or the state ahead is a state of waiting-a-red-light.

Condition 5: from when the vehicle speed is higher than or equal to the high-speed threshold, or when the vehicle speed of the vehicle ahead is higher than or equal to the high-speed threshold, or when the number of the vehicles on the left and right sides is <2, or when the vehicle speeds of the vehicles on the left and right sides higher than or equal to the high-speed threshold.

In the present embodiment, the first buffer time is 1 minute, and the second buffer time is 1 minute.

### Embodiment 4

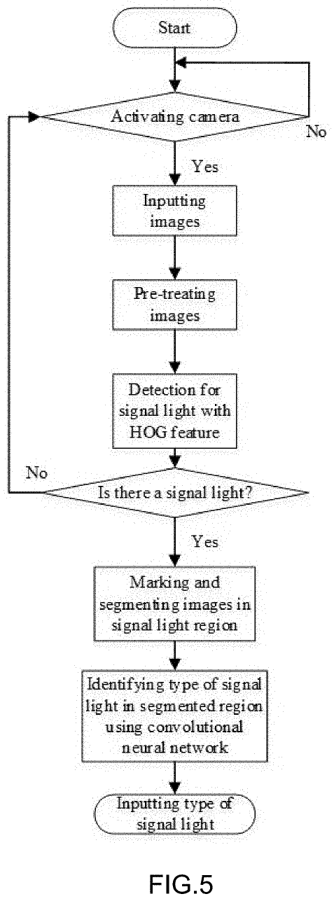

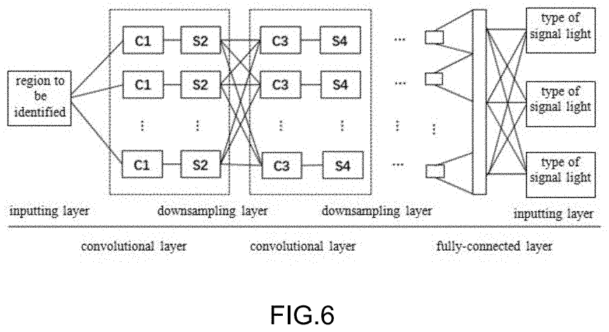

As a supplement to Embodiments 2 and 3, the present embodiment is different from Embodiment 2 or 3 in that: in the present embodiment, as shown in FIGS. 5 and 6, the method for identifying the traffic light state within the image identification rage in the step S1 includes steps of:

S111, activating the camera, acquiring an image information ahead of the vehicle currently, and performing a pre-treatment.

S112, detecting the traffic light by HOG (Histogram of Oriented Gradient) feature detection, and marking the detected traffic light if any and sorting out the image in the identification region if there is a traffic light in the current image information.

S113, analyzing the signal type of the traffic light in the image in the identification region by a convolutional neural network and outputting, wherein the analysis by convolutional neural network is shown in FIG. 6, and the images in the segmented identification region are analyzed by the downsampling layer and finally returned to one of the three traffic light signals.

### Embodiment 5

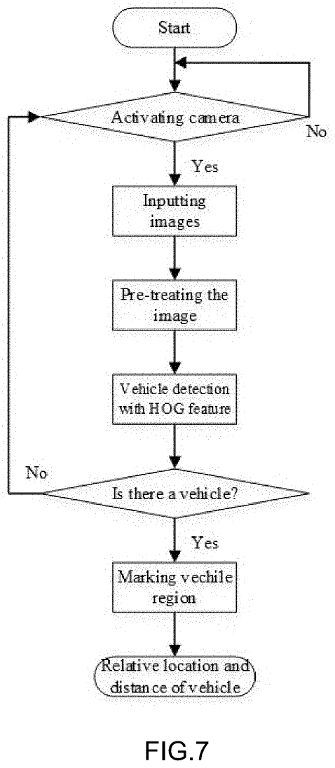

As a supplement to Embodiments 2 and 3, the present embodiment is different from Embodiment 2 or 3 in that: identifying the vehicle within the image identification rage using HOG+SVM (Support Vector Machine) for target detection of the vehicle ahead in the step S1, as shown in FIG. 7, and giving the location of the vehicle, include steps of:

S121, acquiring an image information ahead of the vehicle in the current moment, and performing a pre-treatment;

S122, detecting the vehicle existing in the image by HOG feature detection, and marking the detected vehicle if there is a vehicle in the current image information;

S123, acquiring an actual relative location and distance between the vehicle ahead and the present vehicle according to an orientation and an area of the vehicle in the image, wherein for the analysis of the relative location, the actual relative distance to the vehicle may be acquired by analyzing the location of the vehicle ahead in the image by means of a pre-targeting; after determining the relative location of the vehicle, acquiring multiple images in a continuous time for analyzing to achieve contact capture and tracking of the vehicle ahead; and recording the change in the relative distance between the vehicle ahead and the vehicle during the preset time period; thereby combining the real-time speed of the vehicle to determine the speed of the vehicle ahead.

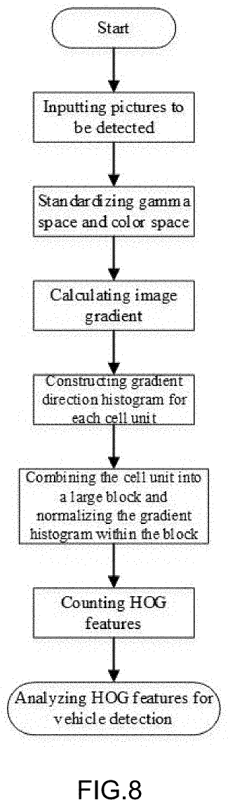

Among them, as shown in FIG. 8, for the HOG feature detection in the step, S122 specifically includes sub-steps of:

S1221, performing a standard treatment on a GAMMA space and a color space of the image;

S1222, calculating the gradient of the image for constructing a gradient direction histogram for each cell unit;

S1223, combining the cell unit into a large block and normalizing the gradient histogram within the block;

S1224, counting and analyzing HOG features for vehicle detection.

The embodiments of the present invention have been described in detail above with reference to the accompanying drawings, but the present invention is not limited to the above embodiments. Various changes may be made within the knowledge of those skilled in the art without departing from the spirit and scope of the present invention.

1: An intelligent start and stop (STT) method for acquiring a road congestion state and an identification state of traffic lights through image data ahead of the vehicle to allow or suppress the intervention of the STT system, characterized in that the acquiring a road congestion state and an identification state of traffic lights comprises steps of:
S1, identifying the presence of a traffic light and a traffic light state ahead of the vehicle by means of image identification; obtaining the vehicle speed of the vehicle within the image identification range by means of image identification, while determining a road congestion state in combination with its own vehicle speed and the traffic light state;
S2, suppressing the intervention of the STT system when the current road congestion state is determined as a traffic congestion; otherwise, determining the current road congestion state as a good road state to allow the intervention of the STT system.

2: The intelligent STT method according to claim 1, characterized in that the determining a single road congestion state in the step S1 includes at least one of the following determining conditions:
determining as the traffic congestion state when its own vehicle speed and the vehicle speed within the image identification rage are smaller than a low-speed threshold and the current state is not a state in red light;
determining as a good road state when its own vehicle speed or any of the vehicle speeds within the image identification rage are smaller than a low-speed threshold and the current state is a state in red light.

3: The intelligent SIT method according to claim 1, characterized in that the road congestion state further includes a temporary congestion state, during which the intervention of the STT system is allowed.

4: The intelligent STT method according to claim 3, characterized in that the determining a single road congestion state in the step S1 includes at least one of the following determining conditions:
determining as the traffic congestion state when its own vehicle speed and the vehicle speed within the image identification rage are smaller than a low-speed threshold and the current state is not a state in red light;
determining as a good road state when its own vehicle speed and any of the vehicle speeds within the image identification rage are larger than a high-speed threshold;
having to enter into the temporary congestion state when the road congestion state is in a good road state and the traffic congestion state is met, and determining as the traffic congestion state when a duration for the temporary congestion state exceeds a first buffer threshold;
determining as the temporary congestion state when the road congestion state is a state of traffic congestion, and a duration for its own vehicle speed being zero exceeds a second buffer threshold, or when in a state of red light currently.

5: The intelligent STT method according to claim 1, characterized in that the method for identifying the traffic light state within the image identification rage in the step S1 includes steps of:
S111, acquiring an image information ahead of the vehicle currently, and performing a pre-treatment;
S112, detecting the traffic light by HOG feature detection, and marking the detected traffic light if any and sorting out the image in the identification region if there is a traffic light in the current image information;
S113, analyzing the signal type of the traffic light in the image in the identification region by a convolutional neural network and outputting.

6: The intelligent STT method according to claim 1, characterized in that the method for identifying the vehicle within the image identification rage in the step S1 includes steps of:
S121, acquiring an image information ahead of the vehicle in the current moment, and performing a pre-treatment;
S122, detecting the vehicle existing in the image by HOG feature detection, and marking the detected vehicle if there is a vehicle in the current image information;
S123, acquiring an actual relative location and distance between the vehicle ahead and the present vehicle according to an orientation and an area of the vehicle in the image.

7: The intelligent STT method according to claim 6, characterized in that the step S122 includes sub-steps of:
S1221, performing a standard treatment on a GAMMA space and a color space of the image;
S1222, calculating the gradient of the image for constructing a gradient direction histogram for each cell unit;
S1223, combining the cell unit into a large block and normalizing the gradient histogram within the block;
S1224, counting and analyzing HOG features for vehicle detection.

8: The intelligent STT method according to claim 1, characterized in that the vehicle within the image identification range includes a vehicle directly ahead of the vehicle and/or a vehicle in an adjacent lane ahead.

9: The intelligent STT method according to claim 1, characterized in that the low-speed threshold is any value between 10 km/h and 20 km/h; the high-speed threshold is any value between 28 km/h and 32 km/h.

10: The intelligent STT method according to claim 1, characterized in that the first buffer threshold is 1 min; the second buffer threshold is 1 min.

11: An intelligent STT system, comprising:
a camera for acquiring an image information reflecting a traffic state ahead of the vehicle;
a processor capturing and analyzing the image information acquired by the camera, and obtaining a traffic light state ahead of the vehicle and a vehicle speed within the image identification range, while determining the road congestion state in combination of its own vehicle speed and the traffic light state and sending a specific command according to the road congestion state;
a start controller for controlling the ignition and flameout of an engine according to the specific command of the processor.

12: The intelligent STT system according to claim 11, characterized in that the road congestion state includes a traffic congestion state, a temporary congestion state, and a good road state; the intervention of the STT system is allowed when in the temporary congestion state and the good road state.
